(19) United States
(12) Patent Application Publication
(10) Pub. No.: US 2025/0342724 A1
(43) Pub. Date: Nov. 6, 2025

(54) INFORMATION PROCESSING DEVICE, INFORMATION PROCESSING SYSTEM, AUTHENTICATION METHOD, AND STORAGE MEDIUM

(71) Applicant: NEC Corporation, Minato-ku, Tokyo (JP)

(72) Inventors: Yuho SHOJI, Tokyo (JP); Takahiro TOIZUMI, Tokyo (JP)

(73) Assignee: NEC Corporation, Minato-ku, Tokyo (JP)

(21) Appl. No.: 18/857,580

(22) PCT Filed: Jul. 21, 2022
(86) PCT No.: PCT/JP2022/028343

§ 371 Date: Oct. 17, 2024

(51) Int. Cl. G06V 40/18; G06V 10/25; G06V 10/32; G06V 10/74

(52) U.S. Cl. CPC G06V 40/197; G06V 10/25; G06V 10/32; G06V 10/761; G06V 40/193

(57) ABSTRACT

Multiple different sub-regions are selected from among sub-regions including at least a portion of an iris region based on features of an eye of a target included in an acquired image. Feature quantities of the respective different sub-regions are calculated. Similarity is calculated between pre-stored features and the respective different sub-regions based on the features of the respective different sub-regions and the pre-stored features. The target is authenticated based on the similarity of the respective different sub-regions.

### TECHNICAL FIELD

The present disclosure pertains to an information processing device, an information processing system, an authentication method, and a storage medium.

### BACKGROUND ART

There is an ensemble learning method in which multiple learners are generated and those multiple different learners are used to output prescribed estimation results with respect to inputs. In this ensemble learning method, each of the multiple learners undergoes learning using the same or different data sets, thereby generating models. These learners are referred to as weak learners. At the time of calculation of estimation results, the estimation results of each weak learner are combined and the results are defined as the overall estimation results. Such ensemble learning may be used for authentication.

Related technologies are disclosed in Non-Patent Document 1 to Non-Patent Document 4. Patent Document 1 discloses technology (bagging) in which multiple sub-data sets are prepared from a training data set by sampling in which redundancy is permitted, and these sub-data sets are used to train individual weak learners.

Patent Document 2 discloses learning technology (boosting) in which, when training a certain weak learner, weights of loss with respect to training data are determined from the output results from other learners. With this method, for example, new learners are trained so as to boost the ability to identify input data for which other learners have yielded erroneous estimation results.

Patent Document 3 discloses learning technology in which, when training weak learners, partial images obtained by randomly cutting out portions of original images are used.

Patent Document 4 discloses technology in which there are weak learners in which iris images are input and weak learners in which eye periphery images are input, and the respective results are combined to output estimation results.

### CITATION LIST

### Non-Patent Documents

Non-Patent Document 1: L. Breiman, “Bagging predictors”, Machine Learning, 24, 123-140, 1996.

Non-Patent Document 2: R. E. Schapire, “A brief introduction to Boosting”, Proceedings of the Sixteenth International Joint Conference on Artificial Intelligence, 1999.

Non-Patent Document 3: B. Cheng, W. Wu, D. Tao, S. Mei, T. Mao and J. Cheng, “Random Cropping Ensemble Neural Network for Image Classification in a Robotic Arm Grasping System”, IEEE Transactions on Instrumentation and Measurement, vol. 69, no. 9, pp. 6795-6806 September 2020, doi: 10.1109/TIM.2020.2976420.

Non-Patent Document 4: Oishi, S., Ichino, M., Yoshiura, H., “Fusion of iris and periocular user authentication by AdaBoost for mobile devices”, 2015 IEEE International Conference on Consumer Electronics (ICCE), 9-12 Jan. 2015, Piscataway, NJ, USA, pp. 428-429 (2015).

### SUMMARY OF INVENTION

### Technical Problem

An objective of the present disclosure is to provide an information processing device, an information processing system, an authentication method, and a storage medium that improve on the documents mentioned above.

### Solution to Problem

According to a first example embodiment disclosed herein, an information processing device includes region selecting means for selecting multiple different sub-regions including at least a portion of an iris region based on features of an eye included in an acquired image; feature calculating means for calculating features of the respective different sub-regions; similarity calculating means for calculating similarity of the respective different sub-regions based on a relationship between the features of the respective different sub-regions and the features of the respective different sub-regions for a person that are pre-stored; and authenticating means for authenticating the person whose eye is included in the acquired image based on the similarity of the respective different sub-regions.

According to a second example embodiment disclosed herein, an information processing device includes region selecting means for selecting one region including at least a portion of an iris region based on features of an eye included in an acquired image; size converting means for converting the one region to different sub-regions with different numbers of pixels; feature calculating means for calculating features of the respective different sub-regions; similarity calculating means for calculating similarity of the respective different sub-regions based on a relationship between the features of the respective different sub-regions and the features of the respective different sub-regions for a person that are pre-stored; and authenticating means for authenticating the person whose eye is included in the acquired image based on the similarity of the respective different sub-regions.

According to a third example embodiment disclosed herein, an information processing system includes region selecting means for selecting multiple different sub-regions from among sub-regions including at least a portion of an iris region based on features of an eye included in an acquired image; feature calculating means for calculating features of the respective different sub-regions; similarity calculating means for calculating similarity of the respective different sub-regions based on a relationship between the features of the respective different sub-regions and the features of the respective different sub-regions for a person that are pre-stored; and authenticating means for authenticating the person whose eye is included in the acquired image based on the similarity of the respective different sub-regions.

According to a fourth example embodiment disclosed herein, an information processing system includes region selecting means for selecting one region including at least a portion of an iris region based on features of an eye included in an acquired image; size converting means for converting the one region to different sub-regions with different numbers of pixels; feature calculating means for calculating features of the respective different sub-regions; similarity calculating means for calculating similarity of the respective different sub-regions based on a relationship between the features of the respective different sub-regions and the features of the respective different sub-regions for a person that are pre-stored; and authenticating means for authenticating the person whose eye is included in the acquired image based on the similarity of the respective different sub-regions.

According to a fifth example embodiment disclosed herein, an authentication method includes selecting multiple different sub-regions from among sub-regions including at least a portion of an iris region based on features of an eye included in an acquired image; calculating features of the respective different sub-regions; calculating similarity of the respective different sub-regions based on a relationship between the features of the respective different sub-regions and the features of the respective different sub-regions for a person that are pre-stored; and authenticating the person whose eye is included in the acquired image based on the similarity of the respective different sub-regions.

According to a sixth example embodiment disclosed herein, an authentication method includes selecting one region including at least a portion of an iris region based on features of an eye included in an acquired image; converting the one region to different sub-regions having different numbers of pixels; calculating similarity of the respective different sub-regions based on a relationship between the features of the respective different sub-regions and the features of the respective different sub-regions for a person that are pre-stored; and authenticating the person whose eye is included in the acquired image based on the similarity of the respective different sub-regions.

According to a seventh example embodiment disclosed herein, a storage medium stores a program for making a computer in an information processing device function as region selecting means for selecting multiple different sub-regions from among sub-regions including at least a portion of an iris region based on features of an eye included in an acquired image; feature calculating means for calculating features of the respective different sub-regions; similarity calculating means for calculating similarity of the respective different sub-regions based on a relationship between the features of the respective different sub-regions and the features of the respective different sub-regions for a person that are pre-stored; and authenticating means for authenticating the person whose eye is included in the acquired image based on the similarity of the respective different sub-regions.

According to an eighth example embodiment disclosed herein, a storage medium stores a program for making a computer in an information processing device function as region selecting means for selecting one region including at least a portion of an iris region based on features of an eye included in an acquired image; size converting means for converting the one region to different sub-regions with different numbers of pixels; feature calculating means for calculating features of the respective different sub-regions; similarity calculating means for calculating similarity of the respective different sub-regions based on a relationship between the features of the respective different sub-regions and the features of the respective different sub-regions for a person that are pre-stored; and authenticating means for authenticating the person whose eye is included in the acquired image based on the similarity of the respective different sub-regions.

### BRIEF DESCRIPTION OF THE DRAWINGS

FIG. 1 is a block diagram illustrating the configuration of an information processing device 1 in a first example embodiment.

FIG. 2 is a diagram illustrating a summary of a feature point detection process in the first example embodiment.

FIG. 3 is a first diagram illustrating a summary of a region selection process in the first example embodiment.

FIG. 4 is a second diagram illustrating a summary of the region selection process in the first example embodiment.

FIG. 5 is a third diagram illustrating a summary of the region selection process in the first example embodiment.

FIG. 6 is a fourth diagram illustrating a summary of the region selection process in the first example embodiment.

FIG. 7 is a diagram indicating a processing flow for a feature recording process performed by the information processing device 1 in the first example embodiment.

FIG. 8 is a diagram indicating a processing flow for an authentication process performed by the information processing device 1 in the first example embodiment.

FIG. 9 is a block diagram illustrating the configuration of an information processing device 1 in a second example embodiment.

FIG. 10 is a diagram indicating a summary of a region selection process in the second example embodiment.

FIG. 11 is a block diagram illustrating the configuration of an information processing device 1 in a third example embodiment.

FIG. 12 is a diagram indicating a summary of region selection and size conversion processes in the third example embodiment.

FIG. 13 is a diagram indicating a processing flow for a feature recording process performed by the information processing device 1 in the third example embodiment.

FIG. 14 is a diagram indicating a processing flow for an authentication process performed by the information processing device 1 in the third example embodiment.

FIG. 15 is a block diagram illustrating the configuration of an information processing device 1 in a fourth example embodiment.

FIG. 16 is a diagram indicating a summary of a region selection process in the fourth example embodiment.

FIG. 17 is a hardware configuration diagram of an information processing device 1.

FIG. 18 is a diagram illustrating the minimum configuration of the information processing device 1.

### EXAMPLE EMBODIMENT

Hereinafter, an information processing device 1 according to one example embodiment of the present disclosure will be described in detail with reference to the drawings. The information processing device 1 according to the present example embodiment improves the authentication performance of targets in authentication technology using ensemble learning.

### First Example Embodiment

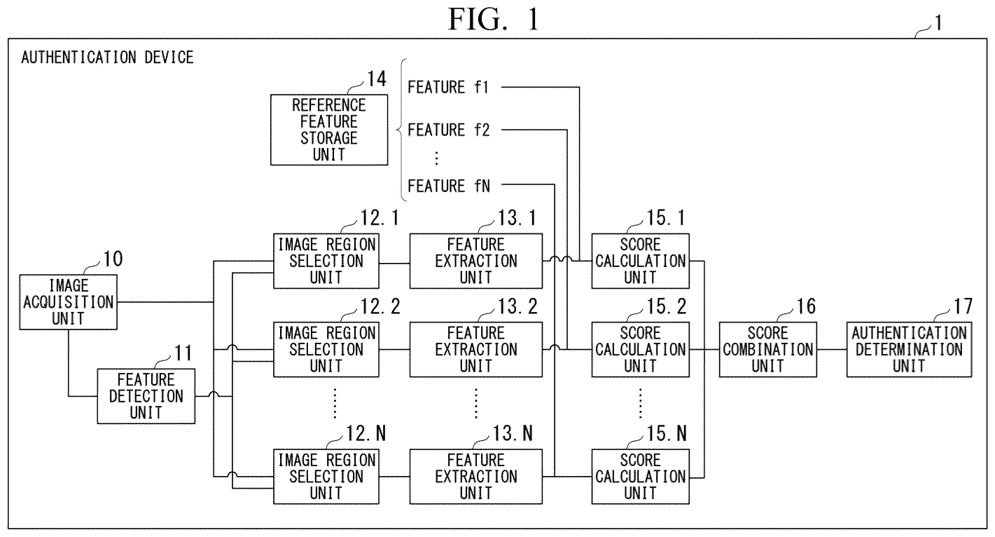

FIG. 1 is a block diagram illustrating the configuration of an information processing device 1 in a first example embodiment.

As illustrated in FIG. 1, the information processing device 1 is provided with an image acquisition unit 10, a feature point detection unit 11, image region selection units 12.1, . . . , 12.N, feature extraction units 13.1, . . . , 13.N, a reference feature storage unit 14, score calculation units 15.1, . . . , 15.N, a score combination unit 16, and an authentication determination unit 17.

The image acquisition unit 10 acquires an image including at least the iris of an eye of a living body that is an authentication target. The image may include not only the iris of the eye, but also the sclera and the area around the eye. The iris refers to the circular area surrounding the pupil with a pattern of eye muscle fibers. The muscle fiber patterns in irises have characteristics that are unique to individual people. The information processing device 1 of the present example embodiment authenticates targets by using at least iris pattern information. This is called iris recognition.

The feature point detection unit 11 detects feature points, which are eye feature information, from the acquired image.

The image region selection units 12.1, . . . , 12.N select, from the image, multiple different sub-regions including at least a portion of an iris region based on feature information, such as eye feature points, detected by the feature point detection unit 11. The image region selection units 12.1, . . . , 12.N respectively operate in parallel and select different sub-regions in the images acquired respectively thereby. The image region selection units 12.1, . . . , 12.N may select sub-regions so as to include the iris region. Any one or more of the image region selection units 12.1, . . . , 12.N may select different sub-regions of the eye including a region of the entire iris. The image region selection units 12.1, . . . , 12.N will be referred to collectively as image region selection units 12.

The feature extraction units 13.1, . . . , 13.N extract the feature f1, . . . , the feature fn for the sub-region a1, . . . , the sub-region an selected by the image region selection units 12.1, . . . , 12.N. The features are values representing features of the iris. The feature extraction units 13.1, . . . , 13.N will be referred to collectively as the feature extraction units 13.

The reference feature storage unit 14 stores reference features indicating pre-registered features of targets. The reference features are, for example, an M-th feature among multiple features of a person pre-registered before recognition, the feature being extracted by the feature extraction unit 13.M and recorded in the reference feature storage unit 14 during a feature pre-registration process.

The score calculation units 15.1, . . . , 15.N use the feature f1, . . . , the feature fn extracted by the feature extraction units 13.1, . . . , 13.N and the reference feature f1, . . . , the reference feature fn stored in the reference feature storage unit 14 to calculate a score SC1, . . . , a score SCn, which are scores for the respective sub-regions. The scores mentioned here are the similarities with the corresponding features that have been pre-registered. The score calculation units 15.1, . . . , 15.N will be referred to collectively as score calculation units 15.

The score combination unit 16 uses the score SC1, . . . , the score SCn obtained from the score calculation units 15.1, . . . , 15.N to calculate a combined score. The combined score is a statistical value of the scores respectively calculated by the score calculation units 15.1, . . . , 15.N.

The authentication determination unit 17 determines authentication based on the combined score obtained from the score combination unit 16.

The target of authentication by the information processing device 1 in the present example embodiment may be a human or an animal such as a dog or a snake.

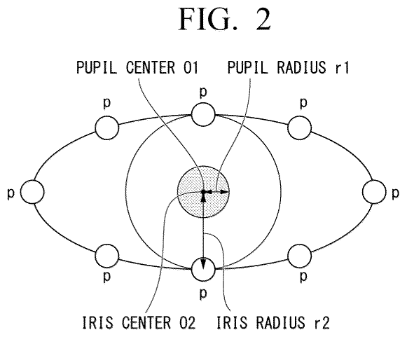

FIG. 2 is a diagram illustrating a summary of a feature point detection process.

The feature point detection unit 11 may detect arbitrary coordinates p in an outline of the eyelids included in an acquired image, the central coordinates O1 of the circle of the pupil, the central coordinates O2 of the circle of the iris, the radius r1 of the pupil, the radius r2 of the iris, etc., and may calculate a vector composed of the values thereof as feature point information. The positions of the central coordinates O1 of the circle of the pupil and of the central coordinates O2 of the circle of the iris may be offset. The arbitrary coordinates p on the outline of the eyelids (upper eyelid, lower eyelid) included in the acquired image may, for example, be values calculated with a prescribed position in the eye at the center of the image. The prescribed position may be a point at the inner corner of the eye or the outer corner of the eye, or may be the midpoint on a line connecting points on the inner corner of the eye and the outer corner of the eye, or the like.

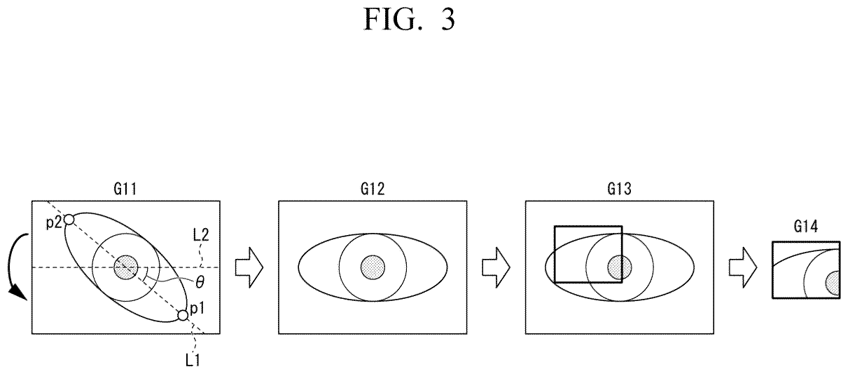

FIG. 3 is a first diagram indicating a summary of a region selection process.

The image region selection units 12.1, . . . , 12.N will be referred to as image region selection units 12. The image region selection units 12 identify a point p1 at the outer corner and a point p2 at the inner corner of an eye appearing in an acquired image (G11), determine the angle θ formed between a straight line L1 passing through those points and the horizontal direction L2 in the image, and use the formed angle θ to generate an image (G12) obtained by rotationally converting the image so that the straight line L1 connecting the point at the outer corner of the eye with the point at the inner corner of the eye is aligned with the horizontal line L2 in the image. The generation of this rotationally-converted image (G12) is one mode of image normalization. The image region selection units 12 identify, in the image (G12), a prescribed sub-region including the iris region (G13), and cut out images (G14) of that sub-region. The image region selection units 12.1, . . . , 12.N are preset so as to cut out images of sub-regions at respectively different positions based on the eye feature information.

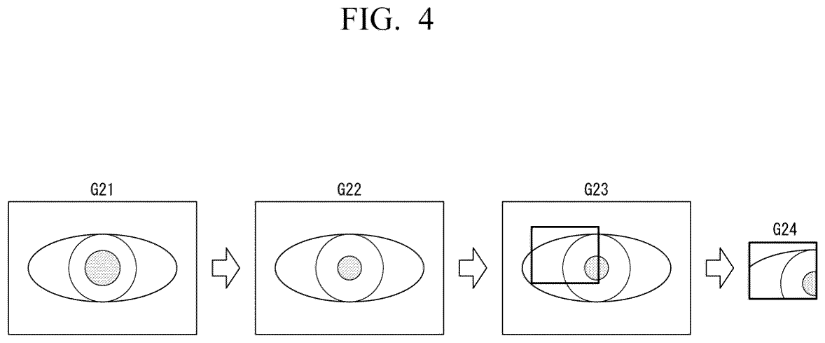

FIG. 4 is a second drawing indicating a summary of a region selection process.

The image region selection units 12 identify the diameter of the pupil or the diameter of the iris in the eyeball of an eye appearing in an acquired image (G21) and generate an image (G22) in which the image is reduced or enlarged so that the diameter of the pupil or the iris becomes a prescribed value. At this time, the image region selection units 12 may generate the reduced or enlarged image by identifying the number of pixels equivalent to the length of the diameter of the iris and the number of pixels equivalent to the length of the diameter of the pupil with reference to the coordinates of the center of the circle of the pupil, and by performing image processing, such as affine conversion, so that the ratio between the number of pixels equivalent to the length of the diameter of the iris and the number of pixels equivalent to the length of the diameter of the pupil is fixed. The generation of this reduced or enlarged image (G22) is one mode of image normalization. The image region selection units 12 may identify the radius of a pupil or the radius of an iris in an eyeball of an eye appearing in an acquired image (G21), and may generate an image (G22) in which the image has been reduced or enlarged so that the radius of the pupil or the iris becomes a prescribed value. The image region selection units 12 identify, in the image (G22), a prescribed sub-region including the iris region (G23), and cut out images (G24) of that sub-region. The image region selection units 12.1, . . . , 12.N cut out images of sub-regions at respectively different positions based on the eye feature information.

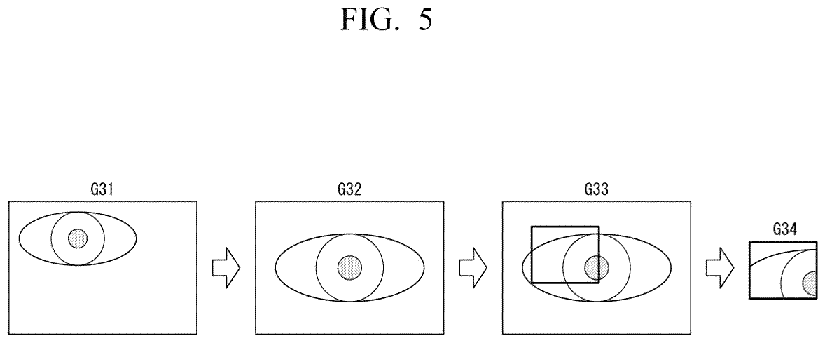

FIG. 5 is a third diagram illustrating a summary of a region selection process.

The image region selection units 12 generate an image (G32) converted so that the position of an eye appearing in an acquired image (G31) is moved to the center of the image. At this time, the image region selection units 12 generate the image (G32) converted so that the position of the coordinates of the center of the circle of the iris becomes a prescribed position in the image, or so that the diameter or radius of the pupil or the iris becomes a prescribed value. The generation of this converted image (G32) is one mode of image normalization. At this time, the image region selection units 12 may generate the converted image (G32) by performing image processing, such as affine conversion, so that the number of pixels equivalent to the length of the radius of the iris with respect to the central coordinates of the circle of the iris is fixed. The image region selection units 12 identify, in the image (G32), prescribed sub-regions including the iris region (G33) and cut out images (G34) of those sub-regions. The image region selection units 12.1, . . . , 12.N cut out images of sub-regions at respectively different positions based on the eye feature information.

The processes indicated in FIG. 3, FIG. 4, and FIG. 5 are one mode of a process for normalizing regions at specific locations in the eye, in an acquired image, so as to have a defined orientation or a defined size.

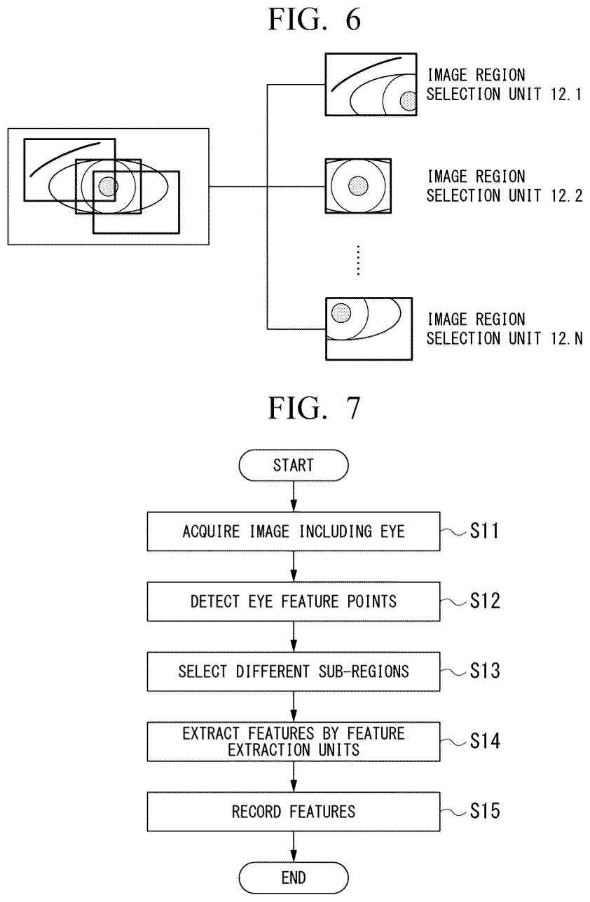

FIG. 6 is a fourth diagram indicating a summary of a region selection process.

The image region selection units 12 may cut out images of prescribed sub-regions based on eye feature information after having sequentially performed any one or more of the processes among the processes explained using FIG. 3, FIG. 4, and FIG. 5 described above. As illustrated in FIG. 6, the image region selection units 12.1, . . . , 12.N cut out images of the sub-regions at respectively different positions based on eye feature information. The sub-regions selected by the respective image region selection units 12 may be multiple different sub-regions having different central positions. The sub-regions selected by the respective image region selection units 12 may be multiple different sub-regions of different sizes. The respective image region selection units 12 may select multiple different sub-regions comprising sub-regions including the range of the eyeball within the region, and sub-regions including the skin, etc. around the eyeball within the region. The image region selection units 12 may select multiple different regions including feature points around the eyeball of the eye. The information processing device 1 according to the present example embodiment uses the features of images of sub-regions that differ in this way to perform ensemble learning, and uses the features of images of said different sub-regions in the recognition process, thereby improving the recognition performance.

FIG. 7 is a diagram indicating a processing flow for a feature recording process performed by the information processing device 1 in the first example embodiment. Next, the feature recording process of the information processing device 1 in the first example embodiment will be explained with reference to FIG. 7.

In a feature recording process that is performed in advance, a certain person inputs a facial image of him/herself to the information processing device 1. The information processing device 1 may use a prescribed camera to capture an image of a range including an eye of the person, and may acquire an image generated at the time of the image capture. The image acquisition unit 10 acquires an image including an eye of the person (step S11). The image acquisition unit 10 may acquire an image in which the prescribed camera has captured the range of the eye of the person, or may acquire an image including the face of the person and cut out an image of a prescribed range including the eye from that image. Said image includes at least one one eye of the target. Additionally, the pupil and the iris of the eye appear in said image. The image acquisition unit 10 outputs the image to the feature point detection unit 11 and the image region selection units 12.1, . . . , 12.N.

The feature point detection unit 11 detects feature points of the eye based on the acquired image (step S12). The feature point detection unit 11 may calculate, as information indicating feature points, a vector including numerical values of the central coordinates and the radius of the iris circle from the acquired image. This vector is information representing feature points of the eye. The feature point detection unit 11 may detect, as feature points of the eye, other features in the iris region. As explained using FIG. 2, the feature point detection unit 11 may generate the information representing feature points of the eye by using, as the information representing feature points of the eye, the central coordinates of the circle of the pupil, the central coordinates of the circle of the iris, the radius of the pupil, the radius of the iris, or arbitrary coordinates on the outlines of the eyelids (upper eyelid, lower eyelid) included in the acquired image. For example, the feature point detection unit 11 may output, as the information indicating the feature points, a vector representing, in addition to numerical values of the radius of the circle of the iris and the central position in the circle of the iris, numerical values of the radius of the pupil and the central position of the pupil circle, and the positional coordinates of features points on the eyelids. The feature point detection unit 11 may calculate, as a vector, information indicating feature points including the central coordinates of the outer circle of the iris, the radius of the outer circle of the iris, the coordinates of the outer corner of the eye, and the coordinates of the inner corner of the eye. Additionally, the feature point detection unit 11 may perform segmentation of the circular regions of the outer circle and the inner circle of the iris, the circular region of the pupil, and the eyelid regions (skin) around the eye; perform circle detection on a two-dimensional map thereof; calculate information indicating feature points including the central coordinates of the outer circle of the iris, the radius of the outer circle of the iris, the coordinates of the outer corner of the eye, and the coordinates of the inner corner of the eye; and output the information as a vector. In the case in which the feature point detection unit 11 cannot perform iris circle detection, the information on the iris region, such as the central coordinates of the outer circle of the iris and the radius of the outer circle of the iris, may be excluded, and information indicating other feature points including the coordinates of the outer corner of the eye and the coordinates of the inner corner of the eye may be output as a vector. The feature point detection unit 11 may be composed of, for example, a recurrent neural network (RNN). The RNN may include multiple convolution layers and multiple activation layers, extract feature points in input images, convert the extracted feature points to a vector representing said region by means of a linear layer, and output the vector as information representing feature points. When the feature point detection unit 11 is constructed as a neural network, a neural network with any structure can be used as long as requirements are met. For example, the structure of the neural network may include structures similar to those of a VGG (Visual Geometry Group), a ResNet (Residual Network), a DenseNet, etc. However, structures other than the above may also be used. The feature point detection unit 11 may be an image processing mechanism not composed of a neural network. The feature point detection unit 11 may use images after the conversion processes (normalization) explained using FIG. 3, FIG. 4, and FIG. 5 have been performed to generate the information representing the feature points of the eye. The feature point detection unit 11 outputs information indicating the feature points to the image region selection units 12.1, . . . , 12.N.

The image region selection units 12.1, . . . , 12.N receive, as inputs, the image input from the image acquisition unit 10 and the information indicating the feature points input from the feature point detection unit 11. The image region selection units 12.1, . . . , 12.N respectively use the image and the information indicating feature points to select different sub-regions using a method as explained in FIG. 3, FIG. 4, and FIG. 5 (step

S13). Images of the sub-regions selected by the image region selection units 12.1, . . . , 12.N are generated. The images of the sub-regions selected by the image region selection units 12.1, . . . , 12.N will be referred to, respectively, as images of the sub-region a1, . . . , the sub-region an. The image region selection unit 12.1 outputs the sub-region a1 to the feature extraction unit 13.1. The image region selection unit 12.2 outputs the sub-region a2 to the feature extraction unit 13.2. Similarly, the image region selection units 12.3, . . . , 12.N output the generated images of the sub-regions to the corresponding feature extraction units 13.

The feature extraction units 13.1, . . . , 13.N extract the features from the input images of the sub-regions after having performed image preprocessing such as, for example, brightness histogram normalization, masking processes on areas other than the iris circle, polar coordinate expansion with the center of the iris circle as the origin, etc. (step S14). The feature extraction units 13.1, . . . , 13.N take images of the sub-region a1, . . . , the sub-region an as inputs and extract the feature f1, . . . , the feature fn.

Additionally, the feature extraction units 13.1, . . . , 13.N may extract the features by using respectively different methods. The feature extraction units 13.1, . . . , 13.N may be constructed, for example, by convolutional neural networks. The feature extraction units 13.1, . . . , 13.N may perform learning in advance by using images of the sub-regions selected in the image region selection units 12.1, . . . , 12.N so as to be able to appropriately extract features. The feature extraction units 13 merely require to be weak learners that use models capable of generating features with good performance, and may be other trained neural networks. Additionally, the feature amount extraction units 13.1, . . . , 13.N may be processing mechanisms for image processes that extract features not composed of neural networks.

The feature extraction units 13.1, . . . , 13.N record the feature f1, . . . , the feature fn (reference features) that have been extracted in the reference feature storage unit 14 so as to be associated with an identifier, etc. of the person appearing in the image used in the feature recording process, or an identifier, etc. of the feature extraction unit 13 that extracted the feature (step S15). As a result thereof, features of different sub-regions of the eye, which are features of the eye of the target appearing in the image used in the feature recording process are respectively recorded in the reference feature storage unit 14.

The information processing device 1 may perform processes similar to those described above for both the left and right eyes appearing in an image, and may record the feature f1, . . . , the feature fn in the reference feature storage unit 14 so as to be further associated with a left-eye or a right-eye identifier. Additionally, the information processing device 1 may similarly perform feature recording processes using images of many targets who are to be provided with prescribed services or processing functions by performing authentication, and may similarly record the features f1, . . . , the features fn in the reference feature storage unit 14. Due to the above processes, the description of the feature recording process performed in advance ends.

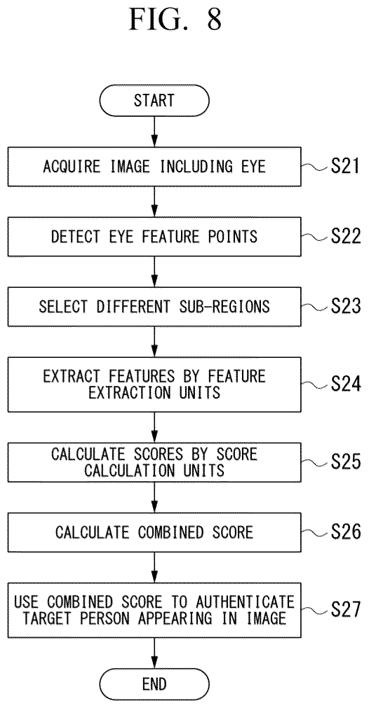

FIG. 8 is a diagram indicating the processing flow of the authentication process performed by the information processing device 1 in the first example embodiment. Next, the authentication process in the information processing device 1 in the first example embodiment will be explained with reference to FIG. 8.

During the authentication process, a certain person inputs a facial image of him/herself to the information processing device 1. The information processing device 1 may use a prescribed camera to capture an image of the person, and may acquire an image generated at the time of the image capture. The image acquisition unit 10 acquires an image including an eye of the person (step S21). Said image includes at least one eye of the target. Additionally, the iris of the eye appears in said image. The image acquisition unit 10 outputs the image to the feature point detection unit 11 and the image region selection units 12.1, . . . , 12.N.

The landmark detection unit 11 detects feature points of the eye based on the acquired image (step S22). This process is similar to the process in step S12 explained in the feature recording process mentioned above.

The image region selection units 12.1, . . . , 12.N receive, as inputs, the image input from the image acquisition unit 10 and the information indicating the feature points input from the feature point detection unit 11. The image region selection units 12.1, . . . , 12.N respectively use the image and the information indicating feature points to select different sub-regions using a method as explained in FIG. 3, FIG. 4, and FIG. 5 (step S23). This process is similar to the process in step S13 explained for the feature recording process described above.

The feature extraction units 13.1, . . . , 13.N extract features from the input images of the selected sub-regions (step S24). This process is similar to the process in step S14 explained in the feature recording process described above. The feature extraction unit 13.1, . . . , 13.N output the features f1, . . . , features fn that have been extracted to corresponding score calculation units 15.

The score calculation units 15.1, . . . , 15.N acquire the feature f1, . . . , the feature fn respectively extracted from the corresponding feature extraction units 13 in the recognition process. Additionally, the score calculation units 15.1, . . . , 15.N acquire features (feature f1, . . . , feature fn) corresponding to one person extracted in the feature recording process recorded in the reference feature storage unit 14. The score calculation units 15.1, . . . , 15.N respectively use the features extracted in the recognition process and the features extracted in the feature recording process to calculate scores (step S25). The scores calculated by the score calculation units 15.1, . . . , 15.N are respectively defined as the score SC1, . . . , the score SCn.

The score calculation units 15.1, . . . , 15.N may calculate the score SC1, . . . , the score SCn by using, for example, the cosine similarity between the features extracted in the recognition process and the features extracted in the feature recording process. Alternatively, the score calculation units 15.1, . . . , 15.N may calculate the scores by using an L2 distance (Euclidean distance) function or an L1 distance (Manhattan distance) function, etc. between the features extracted in the recognition process and the features extracted in the feature recording process. The score calculation units 15.1, . . . , 15.N may determine whether each of the features are similar by making use of properties such as the features of data relating to the same person, such as the cosine similarity, the L2 distance function, the L1 distance function, etc. tending to be closer in distance.

The score calculation units 15.1, . . . , 15.N may be constructed, for example, by neural networks. Additionally, the score calculation units 15.1, . . . , 15.N may be mechanisms for score calculation processes not composed of neural networks, and for example, may calculate the scores by means of the Hamming distances between the features extracted in the recognition process and the features extracted in the feature recording process. The score calculation units 15.1, . . . , 15.N output the calculated recognition scores SC to the score combination unit 16. The scores calculated by the score calculation units 15.1, . . . , 15.N will be referred to, respectively, as the score SC1, . . . , the score SCn.

The score combination unit 16 uses the score SC1, . . . , the score SCn to calculate a combined score (step S26). The score combination unit 16 may calculate the combined score by a method of selecting, for example, the maximum value among the scores SC1, . . . , SCn as the combined score. Alternatively, the score combination unit 16 may calculate the combined score by using a representative value such as the average or the mode of the score SC1, . . . , the score SCn. Alternatively, the score combination unit 16 may calculate the combined score by using an estimation method in a recurrent neural network (RNN) or support vector machine that takes the score SC1, . . . , the score SCn as inputs.

The score combination unit 16 may use, as the means for calculating the combined score, an average or a weighted average of the scores. Additionally, the score combination unit 16 may select the largest among the scores and may calculate the value thereof as the combined score. Additionally, the score combination unit 16 may be constructed, for example, by a neural net. Additionally, the score combination unit 16 may be a processing mechanism not composed of a neural net, and may, for example, use logistic regression or Ridge regression. The score combination unit 16 outputs the combined score to the authentication determination unit 17.

The authentication determination unit 17 acquires the combined score. The authentication determination unit 17 uses the combined score to perform authentication on the person who is the target appearing in the image (step S27). For example, when the combined score is equal to or higher than a threshold value, the authentication determination unit 17 determines that the person appearing in the image is a registered person, and outputs authentication success information. When the combined score is lower than the threshold value, the authentication determination unit 17 determines that the person appearing in the image is a non-registered person, and outputs authentication failure information. The authentication determination unit 17 may identify, in the reference feature storage unit 14, the reference features used for calculating the combined score with the highest value among the combined scores equal to or higher than the threshold value, and may identify the person appearing in the image based on an identifier of the person associated with those reference features. The authentication determination unit 17 may determine that authentication has failed in the case in which the difference between the combined score with the highest value and the combined score with the next highest value among the combined scores equal to or higher than the threshold value is equal to or lower than a prescribed threshold value.

In the information processing device 1 described above, the region selection unit 12 selects multiple different sub-regions from among sub-regions including at least a portion of an iris region based on features of an eye of a target included in an acquired image, and the feature extraction unit 13 calculates features of the respective different sub-regions. Additionally, the score calculation unit 15 calculates the similarity between pre-stored features and the respective different sub-regions based on the features of the respective different sub-regions and the pre-stored features, and the authentication determination unit 17 authenticates the target based on the similarity of the respective different sub-regions. Due to these processes, recognition is performed by using ensemble learning by different weak learners in accordance with different sub-regions including the iris of the eye, and therefore, the recognition performance of targets can be simply increased.

In iris recognition technology, high recognition performance is sought for actual operation. As methods for increasing recognition performance, there are methods of using focused images at higher resolutions. However, there are problems in that expensive cameras are necessary for acquiring images with a large number of pixels, and the constraints on the image capture environment become strict. Therefore, methods for increasing the recognition performance by improving the iris recognition process without satisfying such constraints are sought. As a means for increasing the estimation performance regarding whether or not an image is that of a prestored target during recognition, there is ensemble learning. Ensemble learning is a method that, by combining estimation results from multiple learners, allows estimation with higher performance than the estimation results by the individual learners. For effective ensemble learning, the learners must each be capable of precise estimation and the correlation of the estimation results with respect to each other must be small. In order to increase the ensemble effects in general ensemble learning methods, random numbers are used to divide and generate the training data or learning is performed by linking the weak learners with each other. However, such methods have problems in that they require trial and error in order to increase performance and have high learning costs.

The information processing device 1 according to the present example embodiment, in the case in which an image including an eye has been input, performs feature point detection and uses the obtained feature points to select prescribed sub-regions, thereby allowing multiple sub-regions having respectively different features to be obtained without depending on the iris position in the image of the eye or the state of rotation. Since the images of these sub-regions have iris information while also including different regions, features with little correlation with respect to each other can be reliably extracted. Thus, the information processing device 1 in the present example embodiment can effectively perform ensemble learning without performing trial and error using random numbers, as with general ensemble learning methods.

### Second Example Embodiment

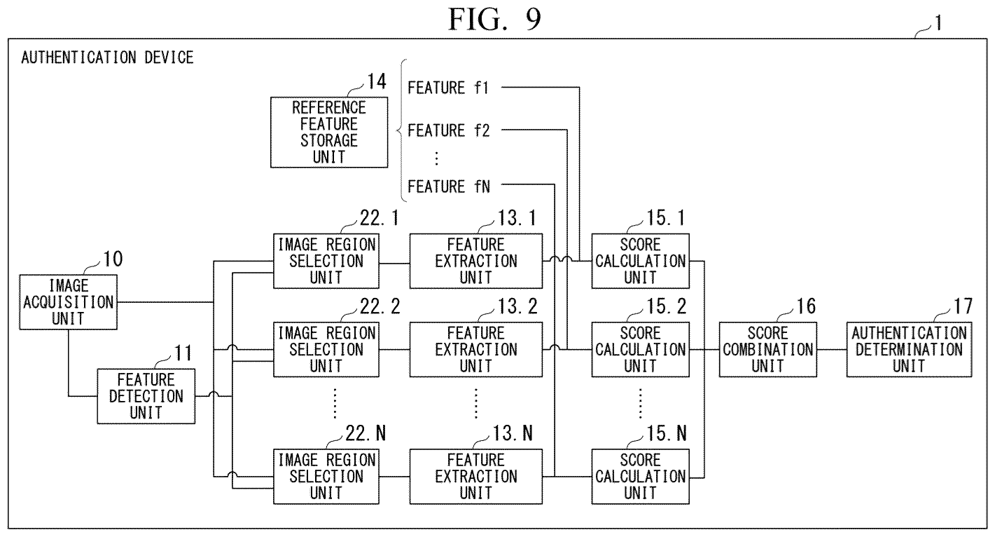

FIG. 9 is a block diagram illustrating the configuration of an information processing device 1 in a second example embodiment.

As illustrated in FIG. 9, the information processing device 1 is provided with an image acquisition unit 10, a feature point detection unit 11, image region selection units 22.1, . . . , 22.N, feature extraction units 13.1, . . . , 13.N, a reference feature storage unit 14, score calculation units 15.1, . . . , 15.N, a score combination unit 16, and an authentication determination unit 17. In the information processing device 1 of the second example embodiment, the process in the image region selection units 22.1, . . . , 22.N differs from the process in the image region selection units 12.1, . . . , 12.N in the information processing device 1 of the first example embodiment. The processes in the other processing units are similar to the processes explained in the first example embodiment. The image region selection units 22.1, . . . , 22.N will be referred to collectively as the image region selection units 22.

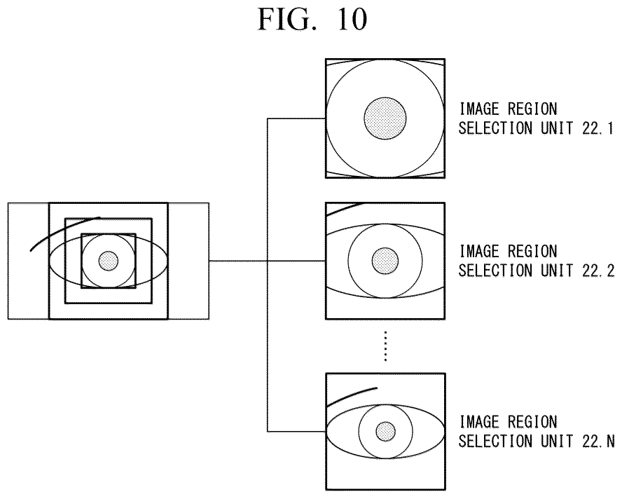

FIG. 10 is a diagram indicating a summary of the region selection process in the second example embodiment.

The region selection units 22.1, . . . , 22.N select sub-regions with different areas having centers at the same position as the center of the iris, as illustrated in FIG. 10, based on the central position of the iris detected by the feature point detection unit 11. In the example in FIG. 10, the image region selection units 22.1, . . . , 22.N select, as the sub-regions, rectangles (squares) having centers at the same position as the center of the iris and having vertices at different distances from the center. The image region selection units 22.1, . . . , 22.N may respectively select sub-regions that are polygonal, such as triangular, or pentagonal or with more sides, having centers at the same position as the center of the iris and having vertices at different distances from the center. The image region selection units 22.1, . . . , 22.N may respectively select sub-regions that are circular, having centers at the same position as the center of the iris and having radii at different distances from the center. The respective sub-regions may include the entire iris. Alternatively, one or more sub-regions with small areas among the sub-regions may include a portion of the iris. The example in FIG. 10 is one mode of a process by which the image region selection unit 22 selects multiple different sub-regions of different sizes having the same central position.

The feature recording process (step S11 to step S15) performed in advance and the authentication process (step S21 to step S27) performed by the information processing device 1 in the second example embodiment are similar to those in the first example embodiment, and as described above, only the sub-region selection methods in the image region selection units 22.1, . . . , 22.N differ. The image region selection units 22.1, . . . , 22.N respectively select rectangular, polygonal, or circular sub-regions having areas of prescribed sizes at the central position of the iris based on a pre-defined program. As a result thereof, the image region selection units 22.1, . . . , 22.N respectively select sub-regions having different areas such that the positions of the centers are at the center of the iris. The image region selection units 22.1, . . . , 22.N according to the second example embodiment, as explained in the first example embodiment, may select the sub-regions by using images after the conversion processes (normalization) explained using FIG. 3, FIG. 4, and FIG. 5 have been performed.

According to the processes in the information processing device 1 of the second example embodiment described above, the image region selection units 22.1, . . . , 22.N respectively select sub-regions with different areas such that the positions of the centers are the center of the iris. Thus, different features are extracted in the respective sub-regions and recognition using ensemble learning is performed with the features. As a result thereof, the information processing device 1 can perform iris recognition with high performance in comparison with the case in which recognition is performed with only features from a single image including the iris.

### Third Example Embodiment

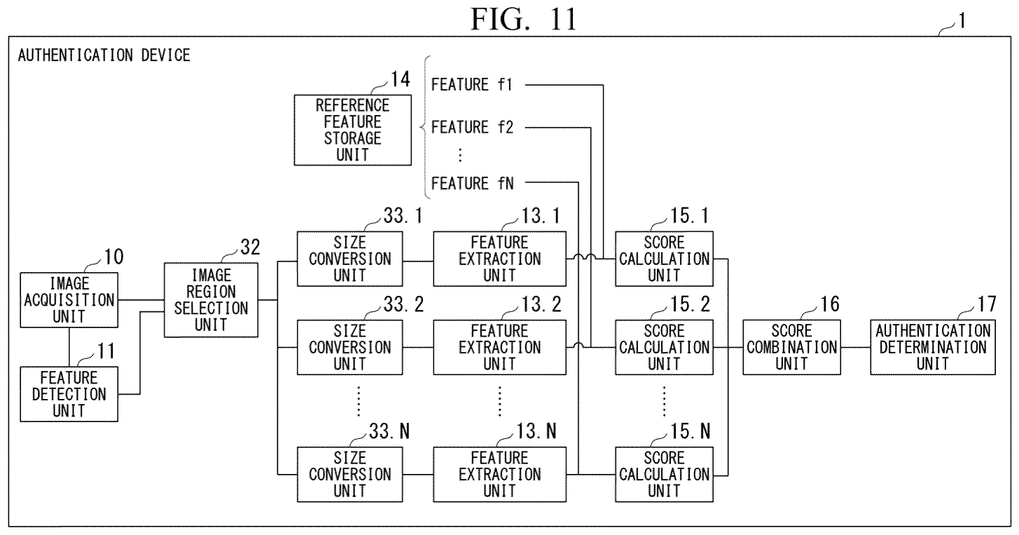

FIG. 11 is a block diagram illustrating the configuration of an information processing device 1 in a third example embodiment.

As illustrated in FIG. 11, the information processing device 1 is provided with an image acquisition unit 10, a feature point detection unit 11, an image region selection unit 32, size conversion units 33.1, . . . , 33.N, feature extraction units 13.1, . . . , 13.N, a reference feature storage unit 14, score calculation units 15.1, . . . , 15.N, a score combination unit 16, and an authentication determination unit 17. The information processing device 1 of the third example embodiment differs from that in the first and second example embodiments in that a single image region selection unit 32 is provided, and size conversion units 33.1, . . . , 33.N are provided. The processes in the processing units other than the image region selection unit 32 and the size conversion units 33.1, . . . , 33.N are similar to the processes explained in the first example embodiment.

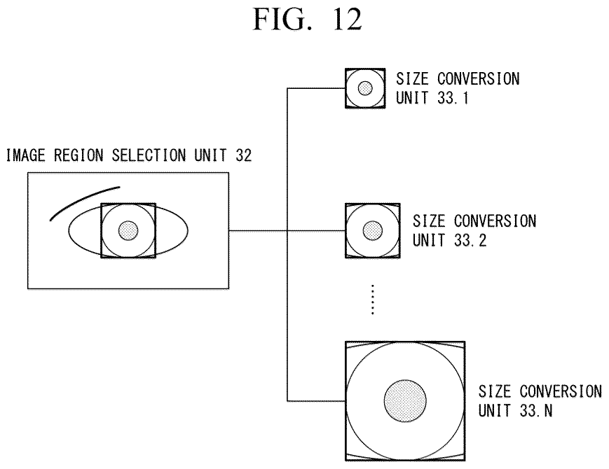

FIG. 12 is a diagram indicating a summary of the region selection and size conversion processes.

The image region selection unit 32 uses feature point information including the central position of the iris and the radius of the iris acquired by the feature point detection unit 11 to select a sub-region (iris region) including the iris in the acquired image. This sub-region may be selected so as to include the entire region of the iris. The selected sub-region may not include a portion of the iris. In other words, the sub-region may be a region including at least a portion of the iris. In the explanation below, it will be assumed that a circular region surrounded by the outer circle of the iris has been selected by the image region selection unit 32. The image region selection unit 32 outputs the sub-region indicating the selected circular region to the respective size conversion units 33.1, . . . , 33.N. The image processed by the image region selection unit 32, as explained in the first example embodiment, may be an image after the conversion processes (normalization) explained using FIG. 3, FIG. 4, and FIG. 5 have been performed. Although FIG. 11 illustrates only one image region selection unit 32, multiple image region selection units 32 may similarly select the same sub-region, and the image information thereof may be output to the size conversion units 33.1, . . . , 33.N.

The size conversion units 33.1, . . . , 33.N acquire image information of the same sub-region from the image region selection unit 32. The size conversion units 33.1, . . . , 33.N respectively convert the acquired image information of the same sub-region to different sizes. The numbers of pixels in the images of the sub-regions may be different after the size conversion units 33.1, . . . , 33.N have respectively converted the sizes thereof. The size conversion units 33.1, . . . , 33.N may, for example perform size conversion by using, as an image interpolating means such that the individuality of the iris is preserved, a method such as Nearest Neighbor interpolation, Bilinear interpolation, or Bicubic interpolation. The size conversion units 33.1, . . . , 33.N may convert the sizes by using other interpolation methods. Additionally, the size conversion units 33.1, . . . , 33.N may be configured by using neural networks.

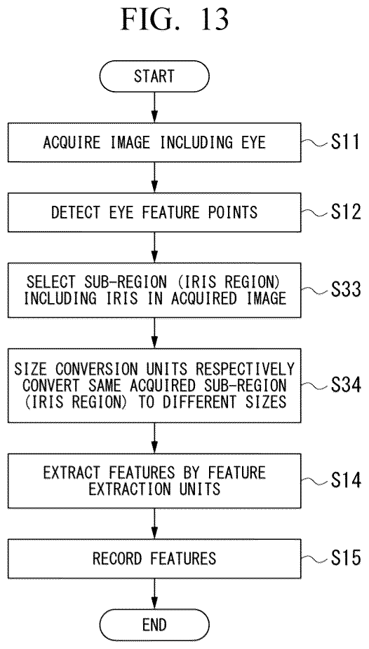

FIG. 13 is a diagram indicating a processing flow for a feature recording process performed by the information processing device 1 in the third example embodiment.

After the information processing device 1 has performed step S11 and step S12 in the feature recording process in the third example embodiment, the image region selection unit 32 selects a sub-region (iris region) including the iris in an acquired image (step S33) by the process explained using FIG. 12. The size conversion units 33.1, . . . , 33.N respectively convert the image information of the same sub-region (iris region) that has been acquired to different sizes (step S34).

Furthermore, the feature extraction units 13.1, . . . , 13.N, as in the process in step S14 in the first example embodiment, extract features after having performed image preprocessing such as, for example, brightness histogram normalization, masking processes on areas other than the iris circle, polar coordinate expansion with the center of the iris circle as the origin, etc. (step S14). Additionally, the feature extraction units 13.1, . . . , 13.N, as in the process in step S15 in the first example embodiment, record the feature f1, . . . , the feature fn (reference features) that have been extracted in the reference feature storage unit 14 so as to be associated with an identifier, etc. of the person appearing in the image used in the feature recording process, or an identifier, etc. of the feature extraction unit 13 that extracted the feature (step S15).

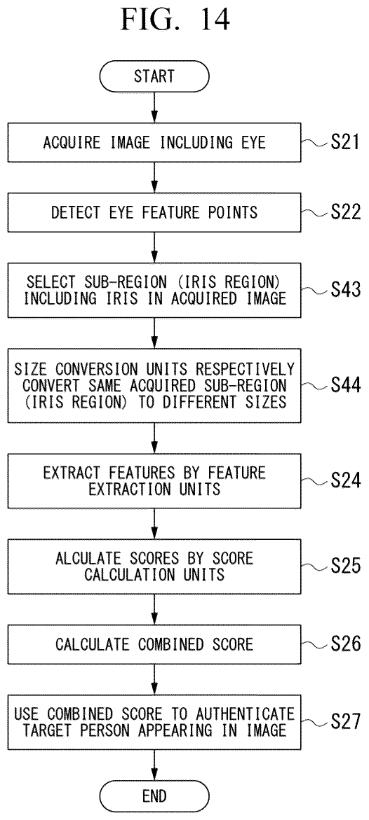

FIG. 14 is a diagram indicating a processing flow for an authentication process performed by the information processing device 1 in the third example embodiment.

In the authentication process in the third example embodiment, after the information processing device 1 has performed steps S21 and step S22 as in the first example embodiment, the image region selection unit 32 selects a sub-region (iris region) including the iris in an acquired image (step S43) by the process explained using FIG. 12. The size conversion units 33.1, . . . , 33.N respectively convert the image information of the same sub-region (iris region) that has been acquired to different sizes (step S44).

The subsequent processes are similar to those in the first example embodiment. In other words, the feature extraction units 13.1, . . . , 13.N extract features from the input image of the sub-region (iris region) (step S24). The score calculation units 15.1, . . . , 15.N respectively use the features extracted in the recognition process and the features extracted in the feature recording process to calculate scores (step S25). The scores calculated by the score calculation units 15.1, . . . , 15.N are respectively defined as the score SC1, . . . , the score SCn. The score combination unit 16 uses the score SC1, . . . , the score SCn to calculate a combined score (step S26). The authentication determination unit 17 uses the combined score to authenticate a person who is a target appearing in the image (step S27).

According to the process in the information processing device 1 of the third example embodiment described above, the feature extraction units 13.1, . . . , 13.N can extract multiple respectively different features having individuality based on images of a sub-region including the iris after size conversion output by the size conversion units 33.1, . . . , 33.N. The information processing device 1 performs recognition using ensemble learning with these features. As a result thereof, the information processing device 1 can perform iris recognition with high performance in comparison with the case in which recognition is performed with only features from a single image including the iris.

### Fourth Example Embodiment

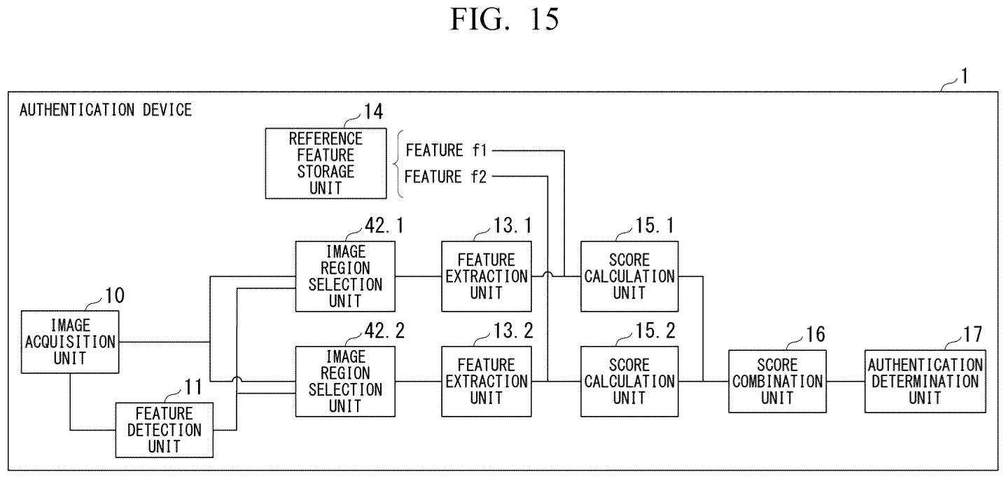

FIG. 15 is a block diagram illustrating the configuration of an information processing device 1 in a fourth example embodiment.

As illustrated in FIG. 15, the information processing device 1 is provided with an image acquisition unit 10, a feature point detection unit 11, image region selection units 42.1, 42.2, feature extraction units 13.1, 13.2, a reference feature storage unit 14, score calculation units 15.1, 15.2, a score combination unit 16, and an authentication determination unit 17. In the information processing device 1 of the fourth example embodiment, the processes in the image region selection units 42.1, 42.2 differ from the processes in the image region selection units 12.1, . . . , 12.N in the information processing device 1 of the first example embodiment. The processes in the other processing units are similar to the processes explained in the first example embodiment.

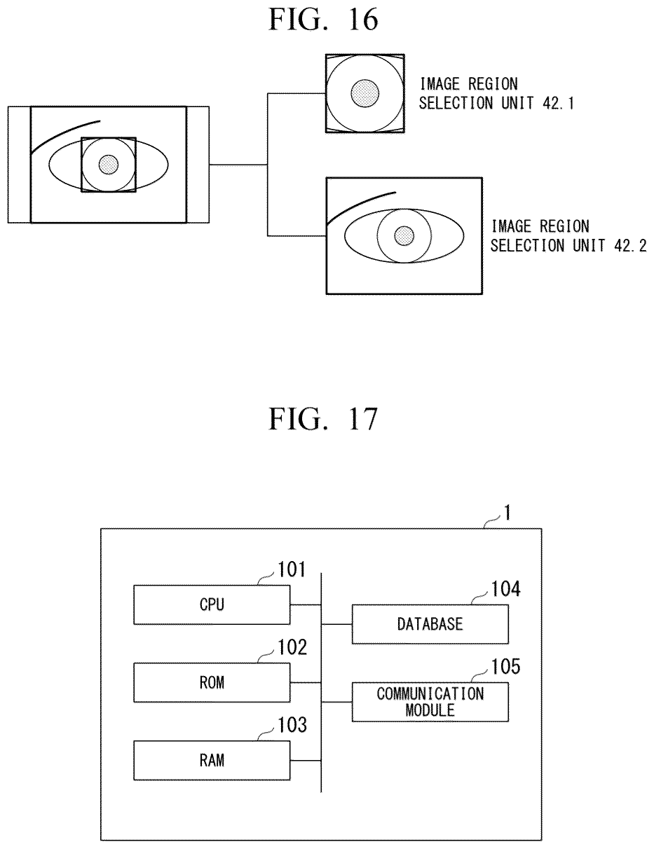

FIG. 16 is a diagram indicating a summary of a region selection process in the fourth example embodiment.

The image region selection units 42.1, 42.2 use feature point information including the central position of the iris and the radius of the iris acquired by the feature point detection unit 11 to respectively select a sub-region (iris region) of a size similar to that of the outer circle of the iris and including the outer circle of the iris in the acquired image, and a sub-region (eye periphery region) including the periphery of the eye other than the iris, such as the outer corner of the eye, the eyelids, and eyelashes (see FIG. 16). The processes in the processing units other than the image region selection units 42.1, 42.2 are similar to those in the first example embodiment. The images processed by the image region selection units 42.1, 42.2, as explained in the first example embodiment, may be images after having performed the conversion processes (normalization) explained by using FIG. 3, FIG. 4, and FIG. 5. The processes indicated in the fourth example embodiment are one mode of a process for the image region selection units 42 to select multiple different sub-regions comprising a sub-region including a region within the range of the eyeball and a sub-region including a region around the eyeball.

The iris region allows many people to be discriminated as long as high-resolution images can be acquired and undergoes very little change over the years. However, there is a problem in that the region is extremely susceptible to degradation of the images due to low resolutions or due to being out of focus or being blurred, etc. On the other hand, eye periphery images include eyelid information and cannot be used to discriminate between many people as well as can be discriminated by the iris region. However, they do not lose the features of individuals even at relatively low resolutions and have features different from the iris. By extracting features respectively from iris images and images of sub-regions including the eye periphery, features that have individuality and that complement each other can be obtained. The information processing device 1 performs recognition using ensemble learning with these features. As a result thereof, in comparison with the case in which recognition is performed only with features from a single image including the iris, the information processing device 1 can perform iris recognition with high performance and can perform a robust recognition process.

In the embodiments described above, an information processing device 1 that performs recognition by using iris images was explained as an example. However, this ensemble learning technology can also be applied to other image processing fields, such as facial recognition and detection (PAD) of fraudulent recognition (presentation attacks) by means of fakes simulating biometric information.

According to the processes in the information processing device 1 in the respective example embodiments described above, estimation processes with low learning costs and including highly performance recognition processes can be executed by using feature information such as positions relating to the eye to perform ensemble learning using images indicating different sub-regions including at least the iris. The reason that highly performance estimation processes can be performed is because, unlike methods of preparing training data sets by using random numbers, etc., by training weak learners using images of sub-regions selected by using detected eye position information, learning can be performed by using images of different sub-regions in respective weak learners while making use of features specific to targets such as individuals, thereby reliably making the correlation between outputs small. The reason the learning cost is small is because the learning by the weak learners in the example embodiments mentioned above can be executed in parallel and there is no need for repeated learning.

FIG. 17 is a hardware configuration diagram of an information processing device 1.

As illustrated in this drawing, the information processing device 1 may be a computer provided with hardware such as a CPU (Central Processing Unit) 101, a ROM (Read-Only Memory) 102, a RAM (Random Access Memory) 103, a database 104, a communication module 105, etc. The functions of the information processing device 1 according to the example embodiments described above may be realized by an information processing system configured so that multiple information processing devices are provided with one or more of the functions described above and cooperate so that the overall process functions.

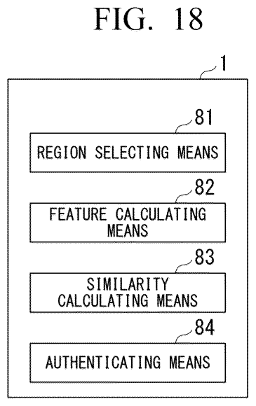

FIG. 18 is a diagram illustrating the minimum configuration of the information processing device 1.

As illustrated in this drawing, the information processing device 1 provides the functions of at least a region selecting means 81, a feature calculating means 82, a similarity calculating means 83, and an authenticating means 84.

The region selecting means 81 selects multiple different sub-regions from among sub-regions including at least a portion of an iris region based on features of an eye of a target included in an acquired image.

The feature calculating means 82 calculates features of the respective different sub-regions.

The similarity calculating means 83 calculates the similarity between pre-stored features and the respective different sub-regions based on the features of the respective different sub-regions and the pre-stored features.

The authenticating means 84 authenticates the target based on the similarity of the respective different sub-regions.

The program described above may be for realizing just some of the aforementioned functions. Furthermore, it may be a so-called difference file (difference program) that can realize the aforementioned functions by being combined with a program already recorded in a computer system.

Some or all of the above-mentioned example embodiments may be described as indicated in the appendices below. However, there is no limitation to those indicated below.

### (Appendix 1)

An information processing device comprising:

region selecting means for selecting multiple different sub-regions from among sub-regions including at least a portion of an iris region based on features of an eye of a target included in an acquired image;

feature calculating means for calculating features of the respective different sub-regions;

similarity calculating means for calculating similarity between pre-stored features and the respective different sub-regions based on the features of the respective different sub-regions and the pre-stored features; and

authenticating means for authenticating the target based on the similarity of the respective different sub-regions.

### (Appendix 2)

The information processing device according to appendix 1, wherein the region selecting means selects the multiple different sub-regions having different central positions.

### (Appendix 3)

The information processing device according to appendix 2, wherein the region selecting means selects the multiple different sub-regions having different sizes.

### (Appendix 4)

The information processing device according to appendix 1, wherein the region selecting means selects the multiple different sub-regions having the same central position and having different sizes.

### (Appendix 5)

The information processing device according to appendix 1, wherein the region selecting means selects multiple different sub-regions comprising a sub-region including a region within a range of an eyeball and a sub-region including a region around the eyeball.

### (Appendix 6)

The information processing device according to any one of appendix 1 to appendix 4, wherein the region selecting means selects the multiple different sub-regions including feature points around an eyeball of the eye.

### (Appendix 7)

The information processing device according to any one of appendix 1 to appendix 4, wherein, in the acquired image, a region of a specific part of the eye is normalized based on at least one of a defined orientation or a defined size.

### (Appendix 8)

An information processing device comprising:

region selecting means for selecting one region including at least a portion of an iris region based on features of an eye of a target included in an acquired image; size converting means for converting the one region to different sub-regions with different numbers of pixels;

feature calculating means for calculating features of the respective different sub-regions;

similarity calculating means for calculating similarity between pre-stored features and the respective different sub-regions based on the features of the respective different sub-regions and the pre-stored features; and

authenticating means for authenticating the target based on the similarity of the respective different sub-regions.

### (Appendix 9)

An information processing system comprising:

region selecting means for selecting multiple different sub-regions from among sub-regions including at least a portion of an iris region based on features of an eye of a target included in an acquired image;

feature calculating means for calculating features of the respective different sub-regions;

similarity calculating means for calculating similarity between pre-stored features and the respective different sub-regions based on the features of the respective different sub-regions and the pre-stored features; and

authenticating means for authenticating the target based on the similarity of the respective different sub-regions.

### (Appendix 10)

An information processing system comprising:

region selecting means for selecting one region including at least a portion of an iris region based on features of an eye of a target included in an acquired image; size converting means for converting the one region to different sub-regions with different numbers of pixels;

feature calculating means for calculating features of the respective different sub-regions;

similarity calculating means for calculating similarity between pre-stored features and the respective different sub-regions based on the features of the respective different sub-regions and the pre-stored features; and

authenticating means for authenticating the target based on the similarity of the respective different sub-regions.

### (Appendix 11)

An authentication method comprising:

selecting multiple different sub-regions from among sub-regions including at least a portion of an iris region based on features of an eye of a target included in an acquired image;

calculating features of the respective different sub-regions;

calculating similarity between pre-stored features and the respective different sub-regions based on the features of the respective different sub-regions and the pre-stored features; and

authenticating the target based on the similarity of the respective different sub-regions.

### (Appendix 12)

An authentication method that comprises:

selecting one region including at least a portion of an iris region based on features of an eye of a target included in an acquired image;

converting the one region to different sub-regions having different numbers of pixels;

calculating features of the respective different sub-regions;

calculating similarity between pre-stored features and the respective different sub-regions based on the features of the respective different sub-regions and the pre-stored features; and

authenticating the target based on the similarity of the respective different sub-regions.

### (Appendix 13)

A storage medium that stores a program for making a computer in an information processing device function as:

region selecting means for selecting multiple different sub-regions from among sub-regions including at least a portion of an iris region based on features of an eye of a target included in an acquired image;

feature calculating means for calculating features of the respective different sub-regions;

similarity calculating means for calculating similarity between pre-stored features and the respective different sub-regions based on the features of the respective different sub-regions and the pre-stored features; and

authenticating means for authenticating the target based on the similarity of the respective different sub-regions.

### (Appendix 14)

A storage medium that stores a program for making a computer in an information processing device function as:

region selecting means for selecting one region including at least a portion of an iris region based on features of an eye of a target included in an acquired image; size converting means for converting the one region to different sub-regions with different numbers of pixels;

feature calculating means for calculating features of the respective different sub-regions;

similarity calculating means for calculating similarity between pre-stored features and the respective different sub-regions based on the features of the respective different sub-regions and the pre-stored features; and

authenticating means for authenticating the target based on the similarity of the respective different sub-regions.

### REFERENCE SIGNS LIST

1 Information processing device (information processing device, information processing system)

10 Image acquisition unit

11 Feature point detection unit

12 (12.1, 12.2, . . . , 12.N), 32, 42 (42.1, 42.4) Image region selection unit (region selecting means)

13 (13.1, 13.2, . . . , 13.N) Feature extraction unit (feature extracting means)

14 Reference feature storage unit

15 (15.1, 15.2, . . . , 15.N) Score calculation unit (similarity calculating means)

16 Score combination unit (similarity calculating means)

17 Authentication determination unit (authenticating means)

What is claimed is:

1. An information processing device comprising:
a storage medium configured to store instructions; and
a processor configured to execute the instructions to:
select multiple different sub-regions from among sub-regions including at least a portion of an iris region based on features of an eye of a target included in an acquired image;
calculate features of the respective different sub-regions;
calculate similarity between pre-stored features and the respective different sub-regions based on the features of the respective different sub-regions and the pre-stored features; and
authenticate the target based on the similarity of the respective different sub-regions.

2. The information processing device according to claim 1, wherein the processor is configured to execute the instructions to select the multiple different sub-regions having different central positions.

3. The information processing device according to claim 2, wherein the processor is configured to execute the instructions to select the multiple different sub-regions having different sizes.

4. The information processing device according to claim 1, wherein the processor is configured to execute the instructions to select the multiple different sub-regions having the same central position and having different sizes.

5. The information processing device according to claim 1, wherein the processor is configured to execute the instructions to select multiple different sub-regions comprising a sub-region including a region within a range of an eyeball and a sub-region including a region around the eyeball.

6. The information processing device according to claim 1, wherein the processor is configured to execute the instructions to select the multiple different sub-regions including feature points around an eyeball of the eye.

7. The information processing device according to claim 1, wherein, in the acquired image, a region of a specific part of the eye is normalized based on at least one of a defined orientation or a defined size.

8. An information processing device comprising:
a storage medium configured to store instructions; and
a processor configured to execute the instructions to:
select one region including at least a portion of an iris region based on features of an eye of a target included in an acquired image;
convert the one region to different sub-regions with different numbers of pixels;
calculate features of the respective different sub-regions;
calculate similarity between pre-stored features and the respective different sub-regions based on the features of the respective different sub-regions and the pre-stored features; and
authenticate the target based on the similarity of the respective different sub-regions.

9-10. (canceled)

11. An authentication method comprising:
selecting multiple different sub-regions from among sub-regions including at least a portion of an iris region based on features of an eye of a target included in an acquired image;
calculating features of the respective different sub-regions;
calculating similarity between pre-stored features and the respective different sub-regions based on the features of the respective different sub-regions and the pre-stored features; and
authenticating the target based on the similarity of the respective different sub-regions.

12-14. (canceled)
